(19) United States
(12) Patent Application Publication
(10) Pub. No.: US 2026/0034966 A1
(43) Pub. Date: Feb. 5, 2026

(54) WIPER BLADE ELEMENT HAVING A LARGE CONTACT SURFACE, FOR A MOTOR VEHICLE

(71) Applicant: VALEO SYSTEMES D'ESSUYAGE, La Verriere (FR)

(72) Inventors: Gerald CAILLOT, La Verriere (FR); Nathalie LALOI, La Verriere (FR); Frederic BRETAGNOL, La Verriere (FR)

(73) Assignee: VALEO SYSTEMES D'ESSUYAGE, La Verriere (FR)

(21) Appl. No.: 18/997,214

(22) PCT Filed: Jun. 26, 2023
(86) PCT No.: PCT/EP2023/067244

§ 371 Date: Jan. 21, 2025

(30) Foreign Application Priority Data
Jul. 22, 2022 (FR) FR2207573

(51) Int. Cl. B60S 1/38

(52) U.S. Cl. CPC B60S 1/38; B60S 2001/3812

(57) ABSTRACT

The invention relates to a novel form of wiper blade having increased dimensions, so that, for each linear millimeter of the wiper blade measured along the longitudinal elongation axis, a surface area of a pressing face via which the wiper blade presses against a glazed surface is greater than 0.25 mm². In addition, the wiper blade includes a solid body configured to allow a hingeless connection to a wiper blade support element, and a pressing body in the form of a continuous or discontinuous structure. The pressing body thus includes macrostructures and microstructures that render the pressing face complex and discontinuous, and give it a surface area that is greater than those of the known wiper blades.

### TECHNICAL FIELD

The technical context of the present invention is that of wiper blades for wipers. More particularly, the invention relates to a large-area wiper blade.

### BACKGROUND OF THE INVENTION

As is known, motor vehicles are equipped with wiping systems able to wash and/or wipe a glazed wall of the motor vehicles, such as a windshield for example. Such wiping systems comprise one or two wipers that are articulated and that cause a wiper blade to press against the glazed surface so as to scrape it in order to remove the water and/or particles present on its surface.

As is known, such wiper blades have a pointed profile, so as to present a reduced area of contact with the glazed surface. This conventional configuration is very widespread because it is able to offer effective scraping while reducing friction forces, noise and wearing of the wiper blades. In general, the contact surface of known wiper blades has a width less than or equal to 100 μm, or even less than 50 μm, measured along a transverse elongation axis perpendicular to a longitudinal elongation axis of the wiper blade considered to be the longest dimension of said wiper blade. Thus, the known wiper blades have a contact surface, for contact with the glazed surface, that takes the form of a very thin continuous line.

One known disadvantage of these known wiper blades is that, in order to ensure optimal effectiveness, the contact surface needs to have a sharply defined profile free of defects and free of geometric irregularities along the longitudinal elongation axis. Thus, such known wiper blades have complex geometries that lead to more demanding manufacturing methods in order to ensure that the expected geometric tolerances are met.

Moreover, when mounted on a wiping system, such known wiper blades are generally mounted on a hinge that extends along the longitudinal elongation axis so as to allow said wiper blade to pivot, according to the direction in which it is moved over the glazed surface. The hinge is generally obtained by means of a thinned-down neck that forms said hinge at an upper end that is the opposite end from the contact surface.

It will therefore be appreciated that wiper blades have particularly complex geometries which lead to high manufacturing and marketing costs.

In particular, the hinge is a zone that is particularly fragile, on account of its slenderness; therefore, the hinge has a tendency to tear over the course of time, even without being used, as a result of the effect of UV radiation and other environmental agents.

Furthermore, such wiper blades present other disadvantages associated with their operation and with the dynamics of inversion imposed by the wiping systems with which they are associated. In particular, the rubbing of these wiper blades at the slender contact surface leads to premature wear and to undesirable operating noise.

In addition, when such wiping systems are stationary they apply a permanent load to the wiper blade both as a result of the forces of friction between the glazed surface and the wiper blade, and of the pressure, imposed by the arm of the wiping system, of being pressed against said glazed surface. Here again, the thinned-down geometry of the wiper blade at its contact surface for contact with the glazed surface, and the slenderness of the hinge, lead to premature ageing and permanent deformation, which over the course of time lessens the performance of the wiper blade.

One object of the present invention is to propose a new wiper blade in order to address, at least for the most part, the foregoing problems and also to afford further advantages.

Another object of the invention is to reduce the ageing of the wiper blade when the wiping system is stationary.

Another object of the invention is to reduce wear, simplify manufacture and reduce manufacturing costs.

[Another object of the invention is to reduce the noise generated by the wiper blade when it is in operation, notably at the moment of the change in direction on the glazed surface.

Another object of the invention is to improve the quality of the contact between the wiper blade and the glazed surface.

### SUMMARY OF THE INVENTION

According to a first aspect of the invention, at least one of the aforementioned objectives is achieved by means of a wiper blade for a motor vehicle wiper, the wiper blade forming a profiled body which extends along a longitudinal elongation axis, the profiled body comprising a pressing face, intended to be brought into contact against a glazed surface of the motor vehicle, the pressing face having a surface area greater than 0.10 mm², preferably greater than 0.25 mm², per linear millimeter of the profiled body measured along the longitudinal elongation axis.

In the context of the present invention, the wiper blade is made from a synthetic or natural material exhibiting both good elasticity and good resistance to tearing or to abrasion. By way of non-limiting example, the material from which the wiper blade is made contains a rubber and/or a plastic.

In the context of the present invention, the wiper blade is made from a single material or from a plurality of materials.

In the context of the present invention, the wiper blade is preferably monolithic, i.e. formed as a single piece, so that it has to be broken or damaged in order to separate one part of the wiper blade from another.

The wiper blade according to the first aspect of the invention is preferably produced by molding. Alternatively, the wiper blade according to the first aspect of the invention is produced using extrusion.

In the context of the present invention, the profiled body of the wiper blade forms a profile which extends along the longitudinal elongation axis with a geometry that is constant or variable.

In the context of the present invention, the pressing face is situated at a lower end of the profiled body, which end is intended to be brought into contact with the glazed surface. The pressing face corresponds to that face of the wiper blade that performs the scraping and/or the wiping of the glazed surface. The pressing face extends along the longitudinal elongation axis of the profiled body of the wiper blade.

In the context of the present invention, the wiper blade is suitable for use on any type of glazed surface, small or large in size, planar or curved. By way of illustration, the glazed surface may notably be selected from among:
a windshield of the motor vehicle or, more generally, any glazed surface of the motor vehicle such as, for example, a side window or a rear screen window; and/or
an optical surface of a sensor, such as notably a LIDAR; and/or
an outer lens enclosing a front headlamp of the motor vehicle.

In the context of the present invention, the following reference axes are defined relative to the wiper blade:
the longitudinal elongation axis, which corresponds to a principal direction of elongation of the wiper blade. The longitudinal elongation axis extends between two transverse edges of the wiper blade. The longitudinal elongation axis corresponds notably to the longest dimension of the wiper blade and/or of the pressing face for pressing against the glazed surface;
a transverse elongation axis, which extends perpendicular to the longitudinal elongation axis, between a front longitudinal edge and a rear longitudinal edge of the wiper blade;
a vertical elongation axis, which extends perpendicular both to the longitudinal elongation axis and to the transverse elongation axis. The vertical elongation axis extends in the direction of the pressing face perpendicular to the longitudinal elongation axis, between said pressing face and an upper edge of the wiper blade.

Thus, the wiper blade according to the first aspect of the invention exhibits a pressing face for pressing against the glazed surface that is markedly greater than the known wiper blades. Rather than having a thinned-down profile with a pressing face taking the form of a continuous filament, the wiper blade according to the first aspect of the invention has a large-area pressing face of which a unit of surface area, per linear millimeter of wiper blade measured along the longitudinal elongation axis, is greater than 0.25 mm². In other words, for each linear millimeter of wiper blade measured along the longitudinal elongation axis, the wiper blade according to the first aspect of the invention has, on its pressing face for pressing against the glazed surface, a surface area of 0.25 mm².

By way of comparison, the known wiper blades which have a thinned-down profile offer a surface area less than or equal to 0.1 mm² per linear millimeter of pressing face measured relative to the longitudinal elongation axis of the wiper blade.

As a result, the wiper blade thus has a larger pressing face, thus improving the scraping and cleaning qualities of the wiper blade according to the first aspect of the invention.

In addition, on account of its larger proportions, the wiper blade according to the first aspect of the invention is stiffer and less sensitive to the effects of permanent deformation caused by a static load applied to the wiper blade by the wiping system when said wiping system is at rest.

The wiper blade according to the first aspect of the invention is intended to be mounted on a hingeless wiper. Rather, the wiper blade according to the first aspect of the invention is configured to be able to be mounted in direct engagement with one or more spinal strips of the wiper, either by means of a central spinal strip that acts as a central core of said wiper or by means of two transverse spinal strips that extend longitudinally along the transverse edges of the wiper blade.

The wiper blade according to the first aspect of the invention advantageously comprises at least one of the refinements below, the technical features that make up these refinements being able to be considered alone or in combination:
the profiled body comprises (i) a solid body intended to be secured to at least one spinal strip of a wiper, and (ii) a pressing body situated in the continuation of the solid body relative to a vertical elongation axis which extends in the direction of the pressing face perpendicular to the longitudinal elongation axis, the pressing face being formed by a free end of the pressing body distal from the solid body. In the context of the present invention, the solid body and the pressing body both extend along the longitudinal elongation axis of the wiper blade according to the first aspect of the invention. The solid body is intended to allow the wiper blade to be fixed to a wiper. The pressing body is situated in the continuation of the solid body. The pressing body is configured to offer the pressing face a specific geometry that is continuous or discontinuous, regular or irregular, as will be described further below;
a width of the wiper blade measured at the pressing body is greater than 500 μm;
according to a first embodiment, the pressing face is simultaneously continuous relative to the longitudinal elongation axis and relative to a transverse elongation axis perpendicular to the longitudinal elongation axis. In this embodiment, the wiper blade according to the first aspect of the invention forms a one-piece entity at the pressing face. In other words, the wiper blade here forms a monolithic assembly having a contact surface that is spread extensively over the glazed surface, rather than a thin line of contact as is present in the known wiper blades.

Here, the contact surface is much larger;
according to a second embodiment, the pressing face is continuous relative to the longitudinal elongation axis only. In this embodiment, the wiper blade according to the first aspect of the invention has one or more continuous profiles that extend along the longitudinal elongation axis of the wiper blade, each profile being distant from a directly adjacent profile;
according to a third embodiment, the pressing face is continuous relative to a transverse elongation axis only, the transverse elongation axis being perpendicular to the longitudinal elongation axis. In this embodiment, the wiper blade according to the first aspect of the invention has one or more continuous profiles that extend along the transverse elongation axis of the wiper blade, each profile being distant from a directly adjacent profile;
in general, according to a fourth embodiment, the pressing face is discontinuous relative to the longitudinal elongation axis and/or relative to a transverse elongation axis perpendicular to the longitudinal elongation axis, the pressing body of the wiper blade comprising a plurality of macrostructures, each macrostructure being distant from the other directly adjacent macrostructures. The macrostructures take the form of protrusions that extend from the solid body or the pressing body. The macrostructures are formed as one with the pressing body;
each macrostructure has a height less than 500 μm, preferably less than 200 μm, and more preferably less than 100 μm, measured along a vertical elongation axis of the wiper blade, the vertical elongation axis being simultaneously perpendicular to the longitudinal elongation axis and to the transverse elongation axis. The height of each macrostructure is measured between a base of said macrostructure, measured either from the solid body or from the pressing body from which it extends.

Advantageously, the height of each macrostructure is greater than 1 μm;
each macrostructure has a width of between 1 μm and 500 μm, measured along the transverse elongation axis or along the longitudinal elongation axis;
each macrostructure takes the form of a prismatic span that extends from the solid body and that forms the pressing body. Each macrostructure takes for example the form of a cylindrical stud, of a parallelepipedal stud, of a spherical or hemispherical stud, or else of a stud of any shape. Advantageously, the pressing body comprises a plurality of macrostructures forming a regular or irregular tiling pattern. In other words, the macrostructures that forms a solid body may each represent one tile, these together forming a tiling pattern of said pressing body so as to maximize the pressing face while at the same time benefiting from a pressing face that is discontinuous in order to better remove the water wiped on the glazed surface by the wiper blade according to the first aspect of the invention;
a distance between two adjacent macrostructures, measured along the transverse elongation axis or the longitudinal elongation axis, is between 1 μm and 100 μm;
[according to a first embodiment variant, the pressing body exhibits an isotropic density of macrostructures along the wiper blade. In this first embodiment variant, relative to the longitudinal elongation axis and/or relative to the transverse elongation axis of the wiper blade, the macrostructures are distributed uniformly.

In other words, the macrostructures exhibit the same distribution in terms of number, the same dimensions, the same surface areas or the same density relative to the longitudinal elongation axis and/or relative to the transverse elongation axis of the wiper blade;
the macrostructures are distributed uniformly along the wiper blade and relative to the longitudinal elongation axis and/or to the transverse elongation axis;
the macrostructures form a periodic array along the wiper blade;
the macrostructures are distributed in a quincunx configuration along the wiper blade;
according to a second embodiment variant, which is an alternative to the first embodiment variant, the pressing body exhibits an anisotropic density of macrostructures along the wiper blade. In this second embodiment variant, relative to the longitudinal elongation axis and/or relative to the transverse elongation axis of the wiper blade, the macrostructures are distributed non-uniformly. In other words, the macrostructures exhibit variations in terms of number, dimensions, surface area or density relative to the longitudinal elongation axis and/or relative to the transverse elongation axis of the wiper blade. This advantageous configuration thus makes it possible to offer mechanical and/or pressing and/or slip and/or friction properties that differ according to the position of the macrostructure on the wiper blade, thus ultimately making it possible to improve the wiping performance of the wiper blade according to the first aspect of the invention;
in particular, a density of macrostructures is at its minimum in a central region of the pressing body, relative to the transverse elongation axis. In other words, a density of macrostructures is at its maximum in a transverse region of the pressing body, which region is situated distant from the longitudinal elongation axis. In general, the macrostructures considered in a transverse region of the pressing body exhibit a density that is higher than that of said macrostructures considered in a central region of the pressing body;
the macrostructures form linear patterns along the wiper blade and along the pressing body;
the macrostructures form non-linear patterns along the wiper blade and along the pressing body;
the macrostructures form curved patterns along the wiper blade and along the pressing body;
the macrostructures form fractal patterns along the wiper blade and along the pressing body;
the pressing body comprises rainwater removal channels for removing rainwater scraped by the wiper blade at the pressing face, the removal channels being formed by mutually distant macrostructures. In particular, the removal channels are directed toward a rear edge of the wiper blade;
the removal channels have a V-shaped or U-shaped transverse profile opening onto the pressing face of the wiper blade. By way of non-limiting example, the removal channels are formed by grooves present in the pressing body and/or between the macrostructures;
in order to improve the interactions between the pressing face of the wiper blade and the glazed surface, and notably the slippage of said face, the pressing body has a texturing of the pressing face. In the context of the present invention, the texturing takes the form of microstructures that are superposed on the pressing body, at the pressing face. In instances in which the pressing body has macrostructures, the texturing is formed on a free end of said macrostructures, which end forms the pressing face of the wiper blade according to the invention.

The dimensions of the texturing are smaller than the dimensions of the macrostructures. The texturing of the pressing face exhibits a height variation of less than 50 μm, measured along the vertical elongation axis. More particularly, the texturing has a roughness Ra of less than 1 μm;
the texturing of the pressing face is, for example, obtained by molding, by laser etching, by chemical attack or by photoetching;
in order to improve the interactions between the pressing face of the wiper blade and the glazed surface, and notably the slippage of said face, the pressing body of the wiper blade according to the invention has a surface treatment on the pressing face. In the context of the present invention, the surface treatment takes the form of a thin layer of a material deposited onto the pressing face of the wiper blade. In particular, the treatment of the pressing surface comprises a material deposited to a thickness of between 2 μm and 15 μm, preferably equal to 10 μm;
the material deposited and that forms the surface coating comprises a graphite-containing paint. Alternatively, the surface treatment is obtained through a liquid process in order to overpolymerize the material used for the pressing body.

A second aspect of the invention proposes a wiper comprising:
a wiper blade according to the first aspect of the invention or according to any one of the refinements thereof; and
a support element to which the wiper blade is secured via at least one spinal strip.

In the context of the present invention, the wiper may be any size so as to be able to collaborate for example with large-sized glazed surfaces such as, for example, a windshield or a rear screen window of a motor vehicle, or else so as to be able to collaborate with smaller-sized glazed surfaces such as, for example, an optical surface of a sensor, for example of LIDAR type, or an outer lens enclosing a tail light or a front headlamp of the motor vehicle.

Particularly cleverly, the wiper blade is connected to the support element without a hinge: the wiper blade is fixed directly to the support element, through a mechanical connection that permits no degree of freedom during the use of the wiper. In other words, the wiper blade according to the first aspect of the invention is mounted fixedly and not in an articulated manner with respect to the support element.

The connection of the wiper blade according to the first aspect of the invention with the support element is afforded by the at least one spinal strip. In the context of the invention, each spinal strip takes the form of an elongate body which extends along the wiper blade, and more particularly in the profiled body or else the solid body thereof. The at least one spinal strip is preferably secured to the solid body of the wiper blade.

In the context of the present invention, according to a first embodiment variant, the connection of the wiper blade to the support element is provided by a single spinal strip secured to an upper face of the solid body. According to a second embodiment variant, the connection of the wiper blade to the support element is provided by two spinal strips each secured to one transverse edge of the wiper blade, each transverse edge extending along the longitudinal elongation axis of said wiper blade.

A third aspect of the invention proposes a wiping system for a glazed surface of a motor vehicle, the wiping system comprising:
a wiper according to the second aspect of the invention, the wiper being intended to be brought into contact with the glazed surface;
a wiper arm configured to drive the rotational and/or translational movement of the wiper;
a connection device configured to securely fix the wiper to the wiper arm.

Particularly cleverly, the connection device establishes a connection without any degree of freedom between the wiper and the wiper arm. In other words, the wiper is mounted fixedly and not in an articulated manner with respect to the wiper arm.

In the context of the present invention, and as described hereinabove, the glazed surface may be of the motor-vehicle windshield type or, more generally, any glazed surface of the motor vehicle such as, for example, a side window or a rear screen window; and/or an optical surface of a sensor, such as notably a LIDAR; and/or an outer lens enclosing a front headlamp of the motor vehicle.

A fourth aspect of the invention proposes a motor vehicle comprising a wiping system according to the third aspect of the invention.

Varying embodiments of the invention are foreseeable, incorporating the various optional features described here in all of their possible combinations.

### BRIEF DESCRIPTION OF DRAWINGS

Further features and advantages of the invention will also become apparent both from the following description and from a number of exemplary embodiments given by way of non-limiting indication with reference to the attached schematic drawings, in which:

FIG. 1 illustrates a first embodiment of a wiper blade according to the first aspect of the invention;

FIG. 2 illustrates a second embodiment of a wiper blade according to the first aspect of the invention;

FIG. 3 illustrates a third embodiment of a wiper blade according to the first aspect of the invention;

FIG. 4 illustrates a fourth embodiment of a wiper blade according to the first aspect of the invention;

FIG. 5 illustrates a detailed view of the pressing face of a fifth embodiment of a wiper blade according to the first aspect of the invention; and

FIG. 6 illustrates a wiper according to the second aspect of the invention.

### DETAILED DESCRIPTION OF THE INVENTION

Of course, the features, variants and different embodiments of the invention can be combined with one another, in various combinations, provided that they are not incompatible or mutually exclusive. In particular, it will be possible to conceive of variants of the invention which comprise only a selection of features described hereinafter in isolation from the other features described, if this selection of features is sufficient to confer a technical advantage or to differentiate the invention from the prior art.

In particular, all of the variants and all of the embodiments described can be combined with one another if there is nothing preventing this combination from a technical perspective.

In the figures, elements that are common to multiple figures retain the same reference sign.

In the figures described hereinafter, the following reference axes are defined in relation to a wiper blade 1 according to the first aspect of the invention:
the longitudinal elongation axis X, which corresponds to a principal direction of elongation of the wiper blade 1. The longitudinal elongation axis X extends between two transverse edges 113 of the wiper blade 1. The longitudinal elongation axis X corresponds notably to the longest dimension of the wiper blade 1 and/or of the pressing face 10 for pressing against the glazed surface SV;
a transverse elongation axis Y which extends perpendicular to the longitudinal elongation axis X, between a front longitudinal edge 112 and a rear longitudinal edge 112 of the wiper blade 1;
a vertical elongation axis Z which extends perpendicular both to the longitudinal elongation axis X and to the transverse elongation axis Y. The vertical elongation axis Z extends from an upper face 111 of the wiper blade 1 and in the direction of the pressing face 10 perpendicular to the longitudinal elongation axis X, between said pressing face 10 and an upper edge of the wiper blade 1.

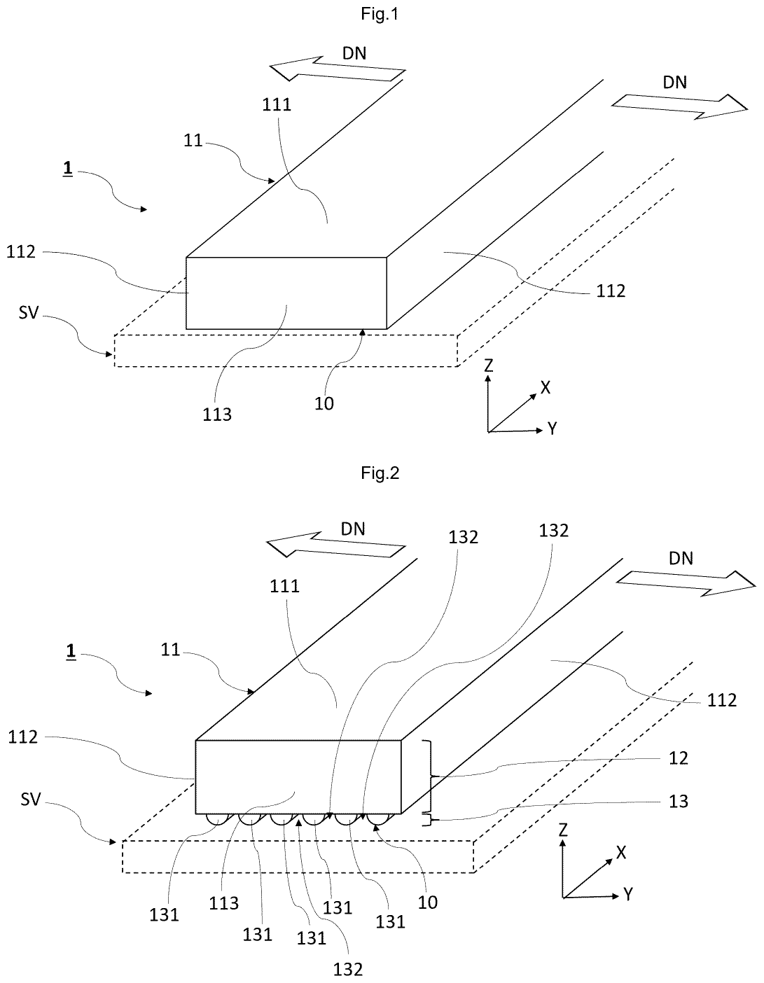

FIG. 1 to FIG. 4 each describe one embodiment of a wiper blade 1 according to the invention, depicting a truncated perspective view of such a wiper blade 1.

A wiper blade 1 for a motor vehicle wiper 2, the wiper blade 1 forming a profiled body 11 which extends along the longitudinal elongation axis X, the profiled body 11 comprising a pressing face 10, intended to be brought into contact against a glazed surface SV of the motor vehicle, the pressing face 10 having a surface area greater than 0.25 mm² per linear millimeter of the profiled body 11 measured along the longitudinal elongation axis X.

In FIG. 1 to FIG. 4, the glazed surface SV is depicted with dotted lines.

In FIG. 1 to FIG. 4, the illustrated profiled body 11 of the embodiments takes a parallelepipedal shape having a rectangular cross section and extending along the longitudinal elongation axis X. Of course, in the context of the invention, the profiled body 11 of the wiper blade 1 may take any shape. In particular, the profiled body 11 may have a cross section that is identical at every point along the longitudinal elongation axis X or may have a cross section that can vary along the longitudinal elongation axis X.

In the embodiments illustrated in FIG. 1 to FIG. 4, the pressing face 10 is situated at a lower end of the profiled body 11, which end is intended to be brought into contact with the glazed surface SV. The pressing face 10 corresponds to that face of the wiper blade 1 that performs the scraping and/or the wiping of the glazed surface SV. The pressing face 10 extends simultaneously along the longitudinal elongation axis X and along the transverse elongation axis Y. Thus, according to the invention, the pressing face 10 is much larger on the wiper blade 1 according to the invention than on the known wiper blades.

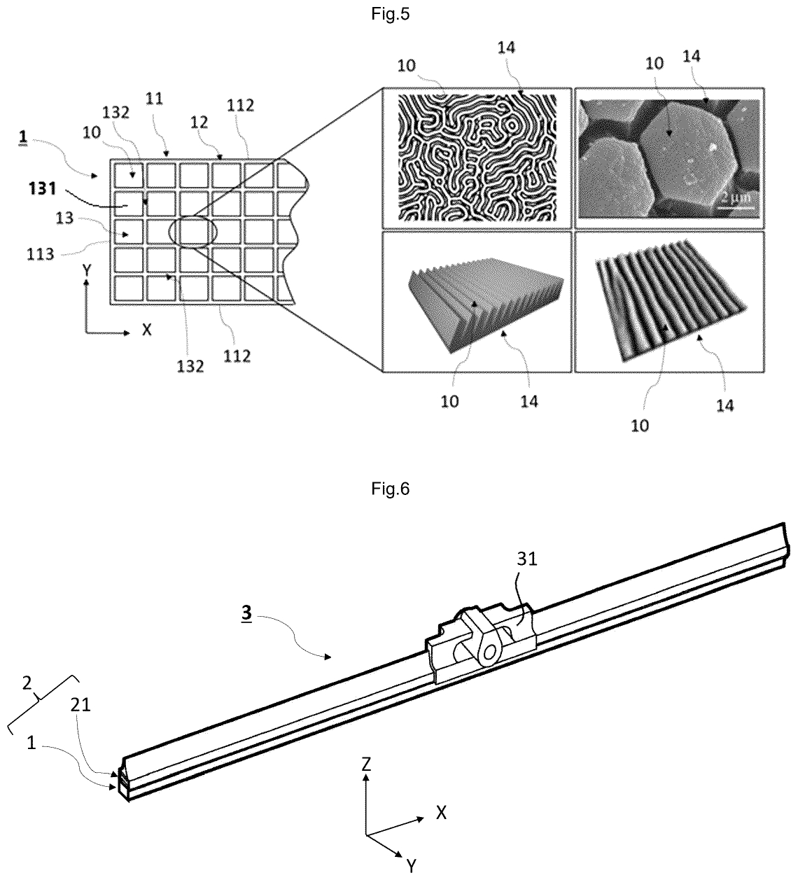

To this end, in the embodiments illustrated in FIG. 1 to FIG. 4, the profiled body 11 forming the wiper blade 1 comprises:
a solid body 12 intended to be secured to at least one spinal strip of a wiper 2. The solid body 12 is intended to allow the wiper blade 1 to be fixed to one or more spinal strips so that the wiper blade 1 can be mounted on the wiper 2. The solid body 12 extends along the longitudinal elongation axis X with a profile that is preferably non-varying. A width of the wiper blade 1 measured at the pressing body 13 is preferably greater than 500 μm, measured along the transverse elongation axis Y; and
a pressing body 13 situated in the continuation of the solid body 12 relative to a vertical elongation axis Z which extends in the direction of the pressing face 10 perpendicular to the longitudinal elongation axis X, the pressing face 10 being formed by a free end of the pressing body 13 distal from the solid body 12. The pressing body 13 extends along the longitudinal elongation axis X and along the transverse elongation axis Y with a profile which may be non-varying, as depicted in FIG. 2 to FIG. 4, or with a profile which may be variable, as depicted in FIG. 5.

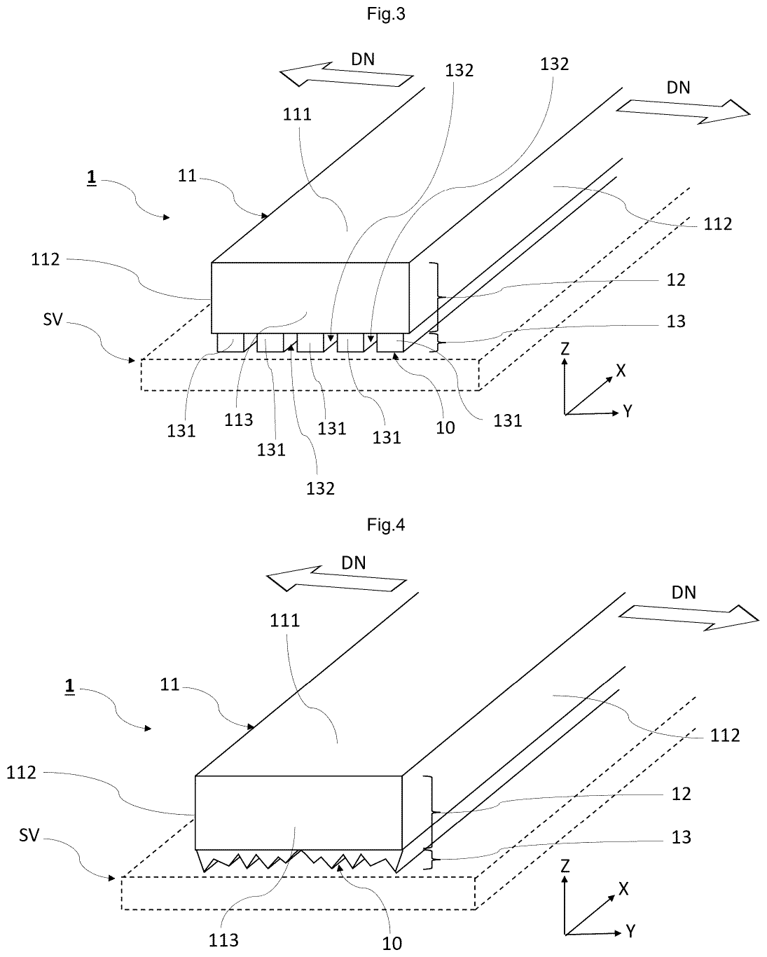

To this end, in the embodiments illustrated in FIG. 2 to FIG. 4, the pressing body 13 takes the form of profiles having a cross section that is invariable along the longitudinal axis:
in the embodiment illustrated in FIG. 2, the pressing body 13 takes the form of circular or semicircular profiles that extend along the longitudinal elongation axis X;
in the embodiment illustrated in FIG. 3, the pressing body 13 takes the form of rectangular or polygonal profiles that extend along the longitudinal elongation axis X;
in the embodiment illustrated in FIG. 4, the pressing body 13 takes the form of a regular or irregular sawtooth profile that extends along the longitudinal elongation axis X.

By contrast, the embodiment illustrated in FIG. 5 shows a pressing body 13 that exhibits a geometry that is discontinuous both along the longitudinal elongation axis and along the transverse elongation axis Y.

The cross section is considered in a plane formed by the transverse elongation axis Y and by the vertical elongation axis Z.

A terminal end of the pressing body 13, considered along the vertical elongation axis Z, forms the pressing face 10 that presses against the glazed surface SV, i.e. that face of the wiper blade 1 that collaborates with the glazed surface SV in order to perform the wiping and/or the scraping.

Particularly advantageously, the wiper blade 1 according to the invention comprises an architecture and a specific geometry along the vertical elongation axis Z. Thus, as described previously, the wiper blade 1 comprises the solid body 12 and the pressing body 13. In addition, the pressing body 13 comprises a plurality of macrostructures 131, each macrostructure 131 being distant from the other macrostructures 131 that are directly adjacent along the longitudinal elongation axis X and/or along the transverse elongation axis Y.

The macrostructures 131 take the form of protrusions that extend from the solid body 12 or the pressing body 13 and along the vertical elongation axis Z.

Each macrostructure 131 has a height of between 1 μm and 100 μm, measured along a vertical elongation axis Z of the wiper blade 1 and/or a width of between 1 μm and 500 μm, measured along the transverse elongation axis Y or along the longitudinal elongation axis X;

Each macrostructure 131 takes the form of a span that extends along the vertical elongation axis Z, with any shape, variable or invariable along the longitudinal elongation axis X and/or along the transverse elongation axis Y. A free end of each macrostructure 131, distal from the solid body 12, forms the pressing face 10 of the wiper blade 1 according to the invention.

In the embodiment illustrated in FIG. 2, the macrostructures 131 that form the pressing body 13 take the form of circular or semicircular profiles that extend along the longitudinal elongation axis X. Each macrostructure 131 thus takes the form of cylindrical or semicylindrical spans that extend along the longitudinal elongation axis X, each macrostructure 131 being spaced away from the macrostructure 131 that is directly adjacent along the transverse elongation axis Y. Dimensions and/or a distance between two macrostructures 131 that are adjacent along the transverse elongation axis Y may be constant or variable depending on the position of the macrostructure 131 concerned relative to the longitudinal elongation axis X.

In the embodiment illustrated in FIG. 3, the macrostructures 131 that form the pressing body 13 take the form of rectangular profiles that extend along the longitudinal elongation axis X. Each macrostructure 131 thus takes the form of prismatic spans that extend along the longitudinal elongation axis X, each macrostructure 131 being spaced away from the macrostructure 131 that is directly adjacent along the transverse elongation axis Y.

Dimensions and/or a distance between two macrostructures 131 that are adjacent along the transverse elongation axis Y may be constant or variable depending on the position of the macrostructure 131 concerned relative to the longitudinal elongation axis X.

In the embodiment illustrated in FIG. 5, the macrostructures 131 that form the pressing body 13 take the form of rectangular studs that are separated from the studs that are directly adjacent along the longitudinal elongation axis X or the transverse elongation axis Y. The macrostructures 131 that form the solid body 12 thus form a two-dimensional array that is regular or irregular so as to maximize the area of the pressing face 10 and to btter remove the water wiped on the glazed surface SV by the wiper blade 1 according to the invention.

In the example illustrated in FIG. 5, a distance between two adjacent macrostructures 131, measured along the transverse elongation axis Y or the longitudinal elongation axis X, is between 1 μm and 1000 μm (1 mm).

In general, the macrostructures 131 may be distributed regularly or irregularly along the wiper blade 1, depending on the effects being sought, notably in terms of friction forces, heating, wear, wiping capacity or capacity to remove rainwater present on the glazed surface SV. In particular, the macrostructures 131 that form the pressing body 13 may exhibit variations in the number and/or dimension and/or surface area and/or density relative to the longitudinal elongation axis X and/or relative to the transverse elongation axis Y of the wiper blade 1, or the macrostructures 131 that form the pressing body 13 may be invariable in terms of dimensions and/or surface area and/or density relative to the longitudinal elongation axis X and/or relative to the transverse elongation axis Y of the wiper blade 1.

In the embodiment illustrated in FIG. 5, the macrostructures 131 are situated at a distance from one another so that the pressing body 13 has rainwater removal channels 132 for removing the rainwater scraped by the pressing face 10 of the wiper blade 1 that presses on the glazed surface SV. The removal channels 132 are formed by macrostructures 131 that are distant from one another. The removal channels 132 have a V-shaped or U-shaped transverse profile opening onto the pressing face 10 of the wiper blade 1.

Finally, in order to improve the interactions between the pressing face 10 of the wiper blade 1 and the glazed surface SV, and notably the slippage of said face, the pressing body 13 has:
a texturing 14 of the pressing face 10, this taking the form of microstructures that are superposed on the pressing body 13 and notably on the macrostructures 131, at the pressing face 10. The dimensions of the texturing 14 are smaller than the dimensions of the macrostructures 131. The texturing 14 of the pressing face 10 exhibits a height variation of less than 50 μm, measured along the vertical elongation axis Z. More particularly, the texturing 14 has a roughness Ra of less than 1 μm; and/or
a surface treatment comprising a thin layer of a material deposited onto the pressing face 10 of the wiper blade 1. In particular, the treatment of the pressing surface 10 comprises a material deposited to a thickness of between 2 μm and 15 μm, preferably equal to 10 μm. The material deposited and that forms the surface coating comprises a graphite-containing paint.

As is visible in FIG. 5, the texturing 14 of the pressing face 10 may take numerous different forms within the context of the invention. It may notably take the form of a one-dimensional or two-dimensional array of crenellations forming a comb that is inclined or upright relative to the longitudinal elongation axis X and/or to the transverse elongation axis Y and/or to the vertical elongation axis Z. The texturing 14 may also take the form of a labyrinthine structure, forming a complex geometry, or else a micro-tiled structure. The technical effects of these microstructures are that they increase the surface area of the pressing face 10, lead to better removal of the scraped rainwater andoffer removal channels 132 at the pressing face 10.

As is visible in FIG. 6, the invention also relates to a wiper 2 comprising:
a wiper blade 1 as described hereinabove; and
a support element 21 to which the wiper blade 1 is secured via at least one spinal strip.

Particularly cleverly, the wiper blade 1 is connected to the support element 21 without a hinge: the wiper blade 1 is fixed directly to the support element 21, through a mechanical connection that permits no degree of freedom during the use of the wiper 2, the wiper blade 1 being mounted fixedly and not in an articulated manner with respect to the support element 21.

In summary, the invention relates to a novel form of wiper blade 1 having increased dimensions, so that, for each linear millimeter of the wiper blade 1 measured along the longitudinal elongation axis X, a surface area of a pressing face 10 via which the wiper blade 1 presses against a glazed surface SV is greater than 0.25 mm². In addition, the wiper blade 1 comprises a solid body 12 configured to allow a hingeless connection to a support element 21 of a wiper 2, and a pressing body 13 taking the form of a continuous or discontinuous structure. The pressing body 13 thus comprises macrostructures 131 and microstructures that render the pressing face 10 complex and discontinuous, and give it a surface area that is greater than those of the known wiper blades.

Of course, the invention is not limited to the examples that have just been described, and numerous modifications may be made to these examples without departing from the scope of the invention. In particular, the various features, forms, variants and embodiments of the invention can be combined with one another, in various combinations, as long as they are not mutually incompatible or mutually exclusive. In particular, all the variants and embodiments previously described can be combined with one another.

What is claimed is:

1. A wiper blade for a motor vehicle wiper, the wiper blade comprising a profiled body which extends along a longitudinal elongation axis, the profiled body includes a pressing face, intended to be brought into contact against a glazed surface of the motor vehicle, wherein the pressing face has a surface area greater than 0.10 mm², preferably greater than 0.25 mm², per linear millimeter of the profiled body measured along the longitudinal elongation axis.

2. The wiper blade as claimed in claim 1, wherein the profiled body includes:
a solid body intended to be secured to at least one spinal strip of a wiper; and
a pressing body situated in the continuation of the solid body relative to a vertical elongation axis which extends in the direction of the pressing face perpendicular to the longitudinal elongation axis, the pressing face being formed by a free end of the pressing body distal from the solid body.

3. The wiper blade as claimed in claim 2, wherein the pressing face is simultaneously continuous relative to the longitudinal elongation axis and relative to a transverse elongation axis perpendicular to the longitudinal elongation axis.

4. The wiper blade as claimed in claim 2, wherein the pressing face is discontinuous relative to the longitudinal elongation axis and/or relative to a transverse elongation axis perpendicular to the longitudinal elongation axis, the pressing body of the wiper blade including a plurality of macrostructures, each macrostructures being distant from the other directly adjacent macrostructures.

5. The wiper blade as claimed in claim 4, wherein each macrostructure has a width of between 1 μm and 500 μm, measured along the transverse elongation axis or along the longitudinal elongation axis.

6. The wiper blade as claimed in claim 4, wherein the pressing body exhibits an isotropic density of macrostructures along the wiper blade.

7. The wiper blade as claimed in claim 4, wherein the pressing body includes rainwater removal channels for removing rainwater scraped by the wiper blade at the pressing face, the removal channels being formed by mutually distant macrostructures.

8. The wiper blade as claimed in claim 7, wherein the pressing body has texturing of the pressing face.

9. A wiper comprising:
a wiper blade, with the wiper blade including a profiled body which extends along a longitudinal elongation axis, the profiled body includes a pressing face, intended to be brought into contact against a glazed surface of the motor vehicle, wherein the pressing face has a surface area greater than 0.25 mm² per linear millimeter of the profiled body measured along the longitudinal elongation axis; and
a support element to which the wiper blade is secured via at least one spinal strip.

10. A wiping system for wiping a glazed surface of a motor vehicle, the wiping system comprising:
a wiper, with the wiper including a wiper blade, with the wiper blade including a profiled body which extends along a longitudinal elongation axis, the profiled body includes a pressing face, intended to be brought into contact against a glazed surface of the motor vehicle, wherein the pressing face has a surface area greater than 0.25 mm² per linear millimeter of the profiled body measured along the longitudinal elongation axis, and a support element to which the wiper blade is secured via at least one spinal strip, the wiper being intended to be brought into contact with the glazed surface;
a wiper arm configured to drive the rotation of the wiper;
a connection device configured to securely fix the wiper to the wiper arm.
